(19) United States
(12) Patent Application Publication
(10) Pub. No.: US 2022/0212938 A1
(43) Pub. Date: Jul. 7, 2022

(54) PROCESS FOR PRODUCING TRICHLOROSILANE WITH STRUCTURE-OPTIMISED SILICON PARTICLES

(71) Applicant: Wacker Chemie AG, Munich (DE)

(72) Inventor: Karl-Heinz Rimböck, Heldenstein (DE)

(73) Assignee: Wacker Chemie AG, Munich (DE)

(21) Appl. No.: 17/607,859

(22) PCT Filed: Apr. 29, 2019
(86) PCT No.: PCT/EP2019/060941

§ 371 Date: Oct. 29, 2021

(51) Int. Cl. C01B 33/107

(52) U.S. Cl. CPC C01B 33/1071; B01J 8/18

(57) ABSTRACT

A process for for producing or preparing chlorosilanes. The process includes providing chlorosilanes having the general formula HₙSiCl₄₋ₙ wherein n is from 1 to 3. Once provided, the chlorosilanes are placed into a fluidized bed reactor where a hydrogen and silicon tetrachloride-containing reaction gas is reacted with a particulate contact mass containing silicon at temperatures of 350° C. to 800° C. The operating granulation is understood as meaning the granulation or granulation mixture introduced into the fluidized bed reactor contains at least 1% by mass of silicon-containing particles S described by a structural parameter S. Where the S has a value of at least 0 and is calculated as follows S=(φ_{S}−0.70)·ρ_{SD}/ρ_{F} where φ_{S} is a symmetry-weighted sphericity factor; the ρ_{SD} is a poured density [g/cm³], and the ρ_{F} is an average particle solids density [g/cm³].

The invention relates to a process for producing chlorosilanes from a hydrogen- and silicon tetrachloride-containing reaction gas and a particulate silicon contact mass containing structurally optimized silicon particles in a fluidized bed reactor.

The production of polycrystalline silicon as a starting material for the manufacture of chips or solar cells is typically carried out by decomposition of volatile halogen compounds thereof, in particular trichlorosilane (TCS, HSiCl₃).

Polycrystalline silicon (polysilicon) may be produced in the form of rods by the Siemens process, wherein polycrystalline silicon is deposited on heated filament rods in a reactor. The process gas employed is typically a mixture of TCS and hydrogen. Alternatively, polycrystalline silicon granulate may be produced in a fluidized bed reactor. Silicon particles are fluidized in a fluidized bed by means of a gas flow, wherein said flow is heated to high temperatures via a heating apparatus. Addition of a silicon-containing reaction gas such as TCS brings about a pyrolysis reaction at the hot particle surface, thus causing the particles to increase in diameter.

The production of chlorosilanes, in particular TCS, may be carried out essentially by three processes which according to WO2016/198264A1 are based on the following reactions:

(1) Si+3HCl→SiHCl₃+H₂+byproducts
(2) Si+3SiCl₄+2H₂→4SiHCl₃+byproducts
(3) SiCl₄+H₂→SiHCl₃+HCl+byproducts

The hydrochlorination (HC) according to reaction (1) makes it possible to produce chlorosilanes from silicon (typically metallurgical silicon (Si_{mg})) by addition of hydrogen chloride (HCl) in a fluidized bed reactor, wherein the reaction proceeds exothermically. This generally affords TCS and STC as the main products.

A further option for producing chlorosilanes, in particular TCS, is the thermal conversion of STC and hydrogen in the gas phase in the presence or absence of a catalyst.

The low temperature conversion (LTC) according to reaction (2) is a weakly endothermic process and is typically performed in the presence of a catalyst (for example copper-containing catalysts or catalyst mixtures). The LTC may be carried out in a fluidized bed reactor in the presence of Si_{mg} under high pressure (0.5 to 5 MPa) at temperatures between 400° C. und 700° C. An uncatalyzed reaction mode is possible using Si_{mg} and/or by addition of HCl to the reaction gas. However, other product distributions may result and/or lower TCS selectivities may be achieved than in the catalyzed variant.

The high temperature conversion according to reaction (3) is an endothermic process. This process is typically carried out in a reactor under high pressure at temperatures between 600° C. and 1200° C.

The known processes are in principle costly and energy intensive. The required energy input which is generally effected by electric means represents a significant cost factor. The operative performance of the LTC in the fluidized bed reactor especially depends decisively on the raw materials employed as well as on the adjustable reaction parameters. A continuous process mode further requires that the reaction components silicon, hydrogen and STC and optionally HCl are introduced into the reactor under the reaction conditions and this is associated with considerable technical complexity. Against this backdrop it is important to realize the highest possible productivity (amount of chlorosilanes formed per unit time and reaction volume) and the highest possible selectivity based on the desired target product (typically TCS) (TCS selectivity-weighted productivity).

The most important parameters influencing the performance of the LTC are in principle the TCS selectivity, the silicon utilization and the formation of byproducts.

The demands on the silicon in terms of chemical composition and particle size distribution for the synthesis of chlorosilanes via HC and MRDS are relatively well studied; by contrast the structural makeup of silicon particles and the influence thereof on the reaction with halide-containing reaction gases has hitherto only been described in relation to intermetallic phases —especially for MRDS. It has not hitherto been described how all three influencing factors must interact in order to operate a particularly high output chlorosilane production process via LTC.

The present invention has for its object to provide a particularly economic process for chlorosilane production via LTC.

The present invention provides a process for producing chlorosilanes of general formula 1

HₙSiCl₄₋ₙ (1),

in which n is 1 to 3,

in a fluidized bed reactor, wherein a hydrogen- and silicon tetrachloride-containing reaction gas is reacted with a particulate contact mass containing silicon at temperatures of 350° C. to 800° C., wherein the operating granulation, understood as meaning the granulation or granulation mixture introduced into the fluidized bed reactor, contains at least 1% by mass of silicon-containing particles S described by a structural parameter S, wherein S has a value of at least 0 and is calculated as follows:

$$S = ( {φ}_{s} - 0.70 ) \cdot \frac{{ρ}_{S D}}{{ρ}_{F}} , \qquad equation ( 1 )$$

wherein

φ_{S} is symmetry-weighted sphericity factor

ρ_{SD} is poured density [g/cm³]

ρ_{F} is average particle solids density [g/cm³].

It has now been found that, surprisingly, the production of chlorosilanes in fluidized bed reactors may be performed particularly economically when silicon-containing particles having certain structural properties are employed in the operating granulation. It was found that this effect is already significantly detectable above a proportion of 1% by mass of the structurally optimized silicon particles in the operating granulation. The use of precisely such silicon particles brings about a lasting reduction in the dust fraction <70 μm described in Lobusevich, N. P et al, “Effect of dispersion of silicon and copper in catalysts on direct synthesis”, Khimiya Kremniiorganich. Soed. 1988, 27 in the production process due to a reduction in dust formation through abrasion. This gives rise to several advantages over the prior art:
higher TCS selectivity
higher silicon utilization (lower losses through dust emission)
more homogeneous contact mass in terms of particle size distribution and resulting improvement in fluid mechanical properties of the fluidized bed
reduction in blocked and/or clogged plant parts due to aggregation of finely divided particles or of dust fractions (particles having a particle size <70 μm)
improved conveyability of the particle mixture
extended reactor uptime (higher plant availability) due to reduced wear

The prejudice of Lobusevich et al. according to which in chlorosilane production TCS selectivity increases only for granulation mixtures of increasing average particle size is also overcome. This is because, according to the invention, the particles S having a structural parameter S of ≥0 preferably have lower average particle sizes than particles having a structural parameter S of <0, thus reducing the average particle size of the operating granulation. Surprisingly, the negative effects to be expected upon reducing average particle size according to the present understanding of the art such as elevated emission of relatively small silicon particles from the reactor and the occurrence of aggregation effects were not observed. On the contrary, the process according to the invention exhibited improved fluidization characteristics of the contact mass in addition to the previously recited advantages.

The term “granulation” is to be understood as meaning a mixture of silicon-containing particles producible for example by so-called atomization or granulation of silicon-containing melts and/or by comminution of chunk silicon by means of crushing and milling plants. The chunk silicon may preferably have an average particle size of >10 mm, particularly preferably >20 mm, in particular >50 mm. Granulation may be classified into fractions essentially by sieving and/or sifting.

A mixture of different granulations may be described as a granulation mixture and the granulations making up the granulation mixture as granulation fractions. Granulation fractions may be graded relative to one another according to one or more properties of the fractions such as for example into coarse grain fractions and fine grain fractions. A granulation mixture may in principle be graded into more than one granulation fraction in defined relative fractions.

The operating granulation describes the granulation or granulation mixture introduced into the fluidized bed reactor.

The symmetry-weighted sphericity factor cps is the product of the symmetry factor and the sphericity. Both shape parameters are determinable by dynamic image analysis according to ISO 13322, wherein the obtained values represent the volume-weighted average over the particular sample of the relevant particle mixture of the operating granulation.

The symmetry-weighted sphericity factor of the particles S is preferably at least 0.70, particularly preferably at least 0.72, very particularly preferably at least 0.75, in particular at least 0.77 and at most 1.

The sphericity of a particle describes the ratio between the surface area of a particle image and the circumference. Thus a spherical particle would have a sphericity approaching 1 while a jagged, irregular particle image would have a roundness approaching zero.

When determining the symmetry factor of a particle the centre of gravity of a particle image is initially determined. Routes from edge to edge through the particular centre of gravity are then drawn in each measurement direction and the ratio of the two resulting route sections measured. The value of the symmetry factor is calculated from the smallest ratio of these radii. For high-symmetry figures such as circles or squares the value of the particular symmetry factor is equal to 1.

Further shape parameters determinable by dynamic image analysis are the width/length ratio (a measure of the extension/elongation of a particle) and the convexity of particles. However, since said parameters are already indirectly contained in the structural parameter S in the form of the symmetry factor they need not be determined in the process according to the invention.

The poured density is defined as the density of a mixture of a particulate solid (so-called bulk solid) and a continuous fluid (for example air) that fills the voids between the particles. The poured density of the grain fraction of the operating granulation having a structural parameter S≥0 is preferably 0.8 to 2.0 g/cm³, particularly preferably 1.0 to 1.8 g/cm³, very particularly preferably 1.1 to 1.6 g/cm³, in particular 1.2 to 1.5 g/cm³. Poured density is determinable according to DIN ISO 697 via the ratio of the mass of the bulk material to the occupied volume of the bulk material.

The average, mass-weighted particle solids density of the particles of the grain fraction having a structural parameter S≥0 is preferably 2.20 to 2.70 g/cm³, particularly preferably 2.25 to 2.60 g/cm³, very particularly preferably 2.30 to 2.40 g/cm³ in particular 2.31 to 2.38 g/cm³. Determination of the density of solid substances is described in DIN 66137-2:2019-03.

The grain fraction having a structural parameter S≥0 is present in the operating granulation preferably in a mass fraction of at least 1% by mass, particularly preferably of at least 5% by mass, very particularly preferably of at least 10% by mass, in particular of at least 20% by mass.

Particles with S≥0 preferably have a particle size parameter d₅₀ which is 0.5 times to 0.9 times the particle size parameter d₅₀ of the particles with S<0.

The operating granulation preferably has a particle size parameter d₅₀ of 70 to 1500 μm, particularly preferably of 80 to 1000 μm, very particularly preferably of 100 to 800 μm, in particular of 120 to 600 μm.

The difference between the particle size parameters d₉₀ and d₁₀ is a measure of breadth of a granulation or a granulation fraction. The quotient of the breadth of a granulation or a granulation fraction and the respective particle size parameter d₅₀ corresponds to the relative breadth. This may be used for example to compare particle size distributions having very different average particle sizes.

The relative breadth of the granulation of the operating granulation is by preference 0.1 to 500, preferably 0.25 to 100, particularly preferably 0.5 to 50, in particular 0.75 to 10.

Determination of particle sizes and particle size distribution may be carried out according to ISO 13320 (laser diffraction) and/or ISO 13322 (image analysis). Calculation of particle size parameters from particle size distributions may be carried out according to DIN ISO 9276-2.

In a further preferred embodiment the operating granulation has a mass-weighted surface area of 80 to 1800 cm²/g, preferably of 100 to 600 cm²/g, particularly preferably of 120 to 500 cm²/g, in particular of 150 to 350 cm²/g.

The granulation mixture of the operating granulation preferably has a p-modal volume-weighted distribution density function, wherein p=1 to 10, preferably p=1 to 6, particularly preferably p=1 to 3, in particular p=1 or 2. For example a 2-modal distribution density function has two maxima.

The use as the contact mass of granulation mixtures having a polymodal (for example p=5 to 10) distribution density function makes it possible to avoid sifting effects (separation of individual grain fractions in the fluidized bed, for example a bipartite fluidized bed). These effects occur especially when the maxima of the distribution density function of the granulation mixture are far apart.

The contact mass is in particular the granulation mixture in contact with the reaction gas. The contact mass thus preferably comprises no further components. Said mass is preferably a silicon-containing granulation mixture containing at most 5% by mass, particularly preferably at most 2% by mass, in particular at most 1% by mass, of other elements as impurities. Said mass is preferably Si_{mg} which typically has a purity of 98% to 99.9%. A typical contact mass is for example a composition comprising 98% by mass of silicon metal, wherein the remaining 2% by mass is generally very largely composed of the following elements selected from: Fe, Ca, Al, Ti, Cu, Mn, Cr, V, Ni, Mg, B, C, P and O. The contact mass may also contain the following elements selected from: Co, W, Mo, As, Sb, Bi, S, Se, Te, Zr, Ge, Sn, Pb, Zn, Cd, Sr, Ba, Y and Cl. The use of silicon having a lower purity of 75% to 98% by mass is also possible. However, the silicon metal proportion is by preference greater than 75% by mass, preferably greater than 85% by mass, particularly preferably greater than 95% by mass.

Some of the elements present in the silicon as impurities have a catalytic activity. The addition of a catalyst is therefore not required in principle. However, the process may be positively influenced by the presence of an additional catalyst, in particular in terms of its selectivity.

The catalyst may be one or more elements from the group comprising Fe, Cr, Ni, Co, Mn, W, Mo, V, P, As, Sb, Bi, O, S, Se, Te, Ti, Zr, C, Ge, Sn, Pb, Cu, Zn, Cd, Mg, Ca, Sr, Ba, B, Al, Y, Cl. The catalyst is preferably selected from the group comprising Fe, Al, Ca, Ni, Mn, Cu, Zn, Sn, C, V, Ti, Cr, B, P, O, Cl and mixtures thereof. As mentioned, these catalytically active elements are already present in silicon in a certain proportion as an impurity, for example in oxidic or metallic form, as silicides or in other metallurgical phases or as oxides or chlorides. Their proportion depends on the purity of the silicon employed.

The catalyst may be added to the operating granulation and/or contact mass for example in metallic, alloyed and/or salt form. Said catalyst may in particular be chlorides and/or oxides of the catalytically active elements. Preferred compounds are CuCl, CuCl₂, CuO or mixtures thereof. The operating granulation may further contain promoters, for example Zn and/or zinc chloride.

The elemental composition of the employed silicon and the contact mass may be determined for example by X-ray fluorescence analysis (XFA), ICP-based analytical methods (ICP-MS, ICP-OES) and/or atomic absorption spectrometry (AAS).

Based on silicon the catalyst is preferably employed in a proportion of 0.1% to 20% by mass, particularly preferably of 0.5% to 15% by mass, in particular of 0.8% to 10% by mass, especially preferably of 1% to 5% by mass.

The grain fractions having structural parameters S<0 and S≥0 are preferably supplied to the fluidized bed reactor as a pre-prepared granulation mixture. Any further constituents of the contact mass may likewise be present. The inventive proportion of a fraction having a structural parameter S≥0 of at least 1% by mass in the operating granulation results in the latter having inter alia better flow and thus conveying characteristics.

The grain fractions having structural parameters S<0 and S≥0 may also be supplied to the fluidized bed reactor separately, in particular via separate feed conduits and containers. Mixing then takes place in principle upon formation of the fluidized bed (in situ). Any further constituents of the contact mass may likewise be supplied separately or as a constituent of either of the two grain fractions.

The process is preferably carried out at a temperature of 400° C. to 700° C., particularly preferably 450° C. to 650° C. The pressure in the fluidized bed reactor is preferably 0.5 to 5 MPa, particularly preferably 1 to 4 MPa, in particular 1.5 to 3.5 MPa.

Before entry into the reactor the reaction gas preferably comprises at least 10% by volume, particularly preferably at least 50% by volume, in particular at least 90% by volume, of hydrogen and silicon tetrachloride.

The molar ratio of hydrogen and silicon tetrachloride is preferably 1:1 to 10:1, particularly preferably 1:1 to 6:1, in particular 1:1 to 4:1.

The reaction gas may further contain one or more components selected from the group of HₙSiCl₄₋ₙ(n=0 to 4), HₘCl₆₋ₘSi₂ (m=0 to 6), HqCl_{6-q}Si₂O (q=0 to 4), (CH₃)ᵤHᵥSiCl₄₋ᵤ₋ᵥ (u=1 to 4 and v=0 or 1) CH₄, C₂H₆, CO, CO₂, O₂, N₂. These components may derive from hydrogen recovered in an integrated system for example.

It is also possible to add HCl and/or Cl₂ to the reaction gas, in particular to allow an exothermic reaction mode and to influence the equilibrium position of the reactions. In this embodiment the reaction gas preferably contains 0.01 to 1 mol of HCl and/or 0.01 to 1 mol of Cl₂ per mol of hydrogen present before entry into the reactor. HCl may also be present in recovered hydrogen as an impurity.

The reaction gas may further contain a carrier gas which does not take part in the reaction, for example nitrogen or a noble gas such as argon.

The composition of the reaction gas is typically determined by Raman and infrared spectroscopy and gas chromatography before it is supplied to the reactor. This may be done either via samples taken in the manner of spot checks and subsequent “off-line analyses” or else via “online” analytical instruments connected to the system.

The chlorosilanes of general formula 1 produced with the process according to the invention are preferably at least one chlorosilane selected from the group of monochlorosilane, dichlorosilane, TCS, Si₂Cl₆ and HSi₂Cl₅. TCS is particularly preferred.

Byproducts that may be generated include further halosilanes, for example monochlorosilane (H₃SiCl), dichlorosilane (H₂SiCl₂), silicon tetrachloride (STC, SiCl₄) and di- and oligosilanes. Impurities such as hydrocarbons, organochlorosilanes and metal chlorides may also be byproducts. In order to produce high-purity chlorosilane of general formula 1 a distillation of the crude product therefore typically follows.

The process according to the invention has preferably been incorporated into an integrated system for producing polycrystalline silicon. The integrated system especially comprises the following processes:
Production of TCS according to the described process.
Purification of the produced TCS to afford semiconductor-quality TCS.
Deposition of polycrystalline silicon, preferably according to the Siemens process or as a granulate.
Further processing of the obtained polycrystalline silicon.

Recycling of the ultrahigh purity silicon dust generated during production/further processing of the polycrystalline silicon.

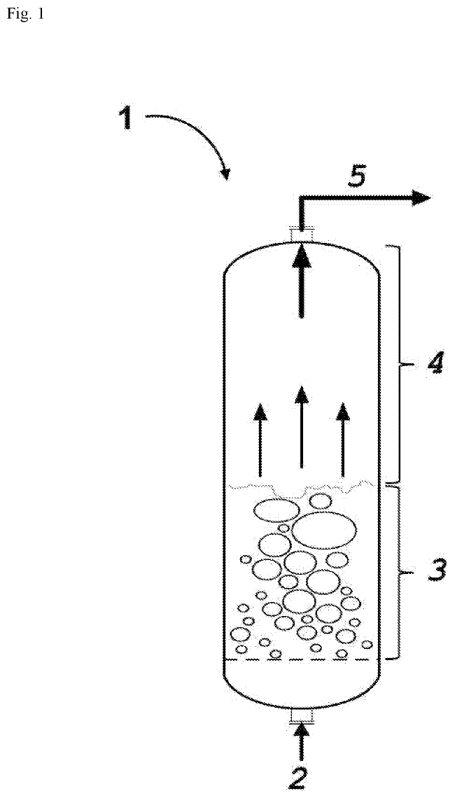

FIG. 1 shows by way of example a fluidized bed reactor 1 for performing the process according to the invention. The reaction gas 2 is preferably blown into the contact mass from below and optionally from the side (for example tangentially or orthogonally to the gas stream from below), thus fluidizing the particles of the contact mass to form a fluidized bed 3. To start the reaction the fluidized bed 3 is generally heated using a heating apparatus arranged externally to the reactor (not shown). Heating is typically not required during continuous operation. A portion of the particles is transported out of the fluidized bed 3 into the void 4 above the fluidized bed 3 with the gas flow. The void 4 is characterized by a very low solids density which decreases in the direction of the reactor outlet 5.

### EXAMPLES

All examples employed silicon of the same type in terms of purity, quality and content of secondary elements and impurities. The grain fractions employed in the operating granulations were produced by crushing chunk Si_{mg} (98.9% by mass Si) and subsequent milling or by atomization techniques known to those skilled in the art to produce particulate Si_{mg} (98.9% by mass Si). Said fractions were optionally classified by sieving/sifting. Grain fractions having certain values for structural parameter S were thus produced in targeted fashion. Contact masses having defined mass fractions of silicon-containing particles having a structural parameter S of not less than 0 were subsequently blended by combining and mixing these grain fractions. The remainder of the grain fractions comprised silicon-containing particles having a structural parameter S of less than 0. The grain fractions together summed to 100% by mass. The granulations employed in the experiments had particle size parameters d₅₀ between 330 and 350 μm. To ensure the greatest possible comparability between the individual experiments no additional catalysts or promoters were added.

The following process was employed in all examples. During the experiments the operating temperature of the fluidized bed reactor was about 520° C. This temperature was kept approximately constant over the entire experimental duration using a heating means and a heat exchanger. The reaction gas composed of H₂ and STC (molar ratio 2.3:1) and the operating granulation were both added in such a way that the height of the fluidized bed remained substantially constant over the entire experimental duration. The reactor was operated at 1.5 MPa of positive pressure over the entire experimental duration. Both a liquid sample and a gas sample were respectively taken at run times of 48 h and 49 h. The condensable proportions of the product gas stream (chlorosilane gas stream) were condensed at −40° C. using a cold trap and analyzed by gas chromatography (GC) before TCS selectivity and [% by mass] were determined therefrom. Detection was via a thermal conductivity detector. In addition, the TCS selectivity-weighted productivity [kg/(kg*h)], i.e. the amount of produced chlorosilanes per hour [kg/h] based on the amount of operating granulation [kg] employed in the reactor weighted with the TCS selectivity, was used as a basis. The obtained values after 48 and 49 h were averaged in each case. After each run the reactor was emptied completely and refilled with operating granulation.

The employed contact masses and the results of the experiments are summarized in table 1. ms is the mass fraction of particles having a structural parameter S>0.

TABLE 1

| | | mS ≥ 0 | TCS | TCS selectivity- |
|---|---|---|---|---|
| | | [% | selectivity | weighted productivity |
| Experiment | S | by mass] | [% by mass] | [kg/(kg*h)] |
| VB1* | 0.005 | 0.02 | 19 | 0.21 |
| VB2* | 0.005 | 0.2 | 20 | 0.22 |
| VB3* | 0.005 | 0.5 | 20 | 0.22 |
| AB1 | 0.005 | 1 | 22 | 0.28 |
| AB2 | 0.005 | 5 | 22 | 0.30 |
| AB3 | 0.005 | 10 | 23 | 0.31 |
| AB4 | 0.005 | 20 | 24 | 0.31 |
| AB5 | 0.005 | 50 | 24 | 0.33 |
| AB6 | 0.005 | 75 | 24 | 0.33 |
| AB7 | 0.005 | 95 | 24 | 0.34 |
| AB8 | 0.050 | 20 | 25 | 0.31 |
| AB9 | 0.053 | 20 | 24 | 0.32 |
| AB10 | 0.040 | 20 | 23 | 0.33 |

*not inventive

1-7. (canceled)

8. A process for producing chlorosilanes, comprising:
providing a chlorosilane of general formula 1
HₙSiCl₄₋ₙ (1),
wherein n is from 1 to 3;
placing the chlorosilane in a fluidized bed reactor, wherein a hydrogen and silicon tetrachloride-containing reaction gas is reacted with a particulate contact mass containing silicon at temperatures of 350° C. to 800° C., wherein the operating granulation, understood as meaning the granulation or granulation mixture introduced into the fluidized bed reactor, contains at least 1% by mass of silicon-containing particles S described by a structural parameter S, wherein S has a value of at least 0 and is calculated as follows:
$$S = ( {φ}_{s} - 0.70 ) \cdot \frac{{ρ}_{S D}}{{ρ}_{F}} , \qquad equation ( 1 )$$
wherein φ_{S} is a symmetry-weighted sphericity factor;
wherein ρ_{SD} is a poured density [g/cm³]; and
wherein ρ_{F} is an average particle solids density [g/cm³].

9. The process of claim 8, wherein the symmetry-weighted sphericity factor Ys of the particles S is from 0.70 to 1 and wherein the sphericity of the particles describes the ratio between a surface area of a particle image and a circumference of the particles.

10. The process of claim 8, wherein the average particle solids density ρ_{F} of the particles having a structural parameter S≥0 is from 2.20 to 2.70 g/cm³ and wherein the determination is carried out according to DIN 66137-2:2019-03.

11. The process of claim 8, wherein the operating granulation has a particle size parameter d₅₀ of 70 to 1500 μm and wherein the particle size parameter is determined according to DIN ISO 9276-2.

12. The process of claim 8, wherein before entry into the reactor the reaction gas preferably comprises at least 10% by volume of hydrogen and silicon tetrachloride.

13. The process of claim 8, wherein the molar ratio of hydrogen and silicon tetrachloride is from 1:1 to 10:1.

14. The process of claim 8, wherein the produced chlorosilane of general formula 1 is trichlorosilane (TCS).
